(19) United States
(12) Patent Application Publication
(10) Pub. No.: US 2015/0121535 A1
(43) Pub. Date: Apr. 30, 2015

(54) MANAGING GEOGRAPHICAL LOCATION INFORMATION FOR DIGITAL PHOTOS

(71) Applicant: Microsoft Corporation, Redmond, WA (US)

(72) Inventor: Xander Fiss, Kirkland, WA (US)

(73) Assignee: Microsoft Corporation, Redmond, WA (US)

(21) Appl. No.: 14/067,693

(22) Filed: Oct. 30, 2013

(51) Int. Cl. G06F 21/62

(52) U.S. Cl. CPC G06F 21/6218
USPC 726/26

(57) ABSTRACT

Techniques are described for managing geographical location information for digital photos. For example, sensitive geographical areas can be created and privacy options defined for managing digital photos taken within the sensitive geographical areas. The privacy options can comprise an option to not include the current geographical location in digital photos when taken and an option to include a generalized geographical location, instead of the current geographical location, in digital photos when taken. Geographical location information can also be managed when digital photos are shared.

### BACKGROUND

Smart phones with integrated cameras are ubiquitous. These devices typically have Global Positioning System (GPS) receivers that determine latitude and longitude when a photograph is taken and place this information into the meta-data of the photo. While this can be convenient, it also presents a security risk to the user by potentially exposing sensitive location information, such as the user's home address, when the photo is shared. Many users are not even aware that this information is contained in their personal photographs.

Therefore, there exists ample opportunity for improvement in technologies related to managing geographical location information for digital photos.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and tools are described for managing geographical location for digital photos. In some implementations, managing geographical location can be accomplished by creating sensitive geographical areas. For example, a user can define sensitive geographical areas and then define privacy options to control how geographical location information is handled for digital photos taken within the sensitive geographical areas. For example, digital photos can be taken and saved without the current geographical location, or digital photos can be taken and saved with a generalized geographical location used in place of the current geographical location.

Privacy options can also be defined to control how geographical location information is handled for digital photos when shared. For example, geographical location information can be removed, or replaced with a generalized geographical location, when sharing digital photos

As described herein, a variety of other features and advantages can be incorporated into the technologies as desired.

### BRIEF DESCRIPTION OF THE DRAWINGS

FIG. 1 depicts an example user interface for setting privacy options for digital photos.

FIG. 2 depicts an example user interface for creating sensitive areas.

FIG. 3 depicts an example user interface for creating a sensitive area with a random offset.

FIG. 4 depicts an example user interface for creating a sensitive area using a free-form drawing tool.

FIG. 5 depicts an example user interface for setting privacy options for digital photos including a generalized geographical location.

FIG. 6 depicts an example user interface for setting privacy options for use when sharing digital photos.

FIG. 7 depicts a flowchart of an example method for managing geographical location of digital photos.

FIG. 8 depicts a flowchart of an example method for managing geographical location of digital photos when inside and when outside sensitive geographical areas.

FIG. 9 depicts a flowchart of an example method for managing geographical location of digital photos according to privacy options.

FIG. 10 is a diagram of an example computing system in which some described embodiments can be implemented.

FIG. 11 is an example mobile device that can be used in conjunction with the technologies described herein.

FIG. 12 is an example cloud-support environment that can be used in conjunction with the technologies described herein.

### DETAILED DESCRIPTION

### Overview

As described herein, various techniques and solutions can be applied for managing geographical location information for digital photos. In some implementations, managing geographical location information can be accomplished by creating sensitive geographical areas. For example, a user can define sensitive geographical areas and then define privacy options to control how geographical location information is handled for digital photos taken within the sensitive geographical areas.

A user can create sensitive geographical areas using a variety of user interface tools. For example, a user can define a geographical location (e.g., a specific address or point on a map) and then define a radius from that location thus defining a circular geographical area. As another example, a user can define a geographical location using a free-form drawing tool (e.g., to draw an arbitrary shape, or a specific shape such as a square or rectangle, on a displayed map). Options can be selected to enhance the privacy of digital photos taken within the area, such as a random offset of the sensitive area (e.g., so that the center of the area is not the location selected by the user).

A user can select from a variety of privacy options to manage the geographical location of digital photos taken within sensitive geographical areas. For example, a privacy option can be provided to use a generalized geographical location, instead of the current geographical location, in digital photos when taken within sensitive geographical areas. Another privacy option can be provided to not include the current geographical location in digital photos when taken within sensitive geographical areas. Additional and/or other privacy options can also be provided, such as a global option to include or not include current geographical location as a default setting (e.g., a setting to apply when not within any sensitive geographical areas).

A user can select from a variety of privacy options to manage geographical location when sharing digital photos (e.g., when emailing digital photos, when sending digital photos to a social media site or photo sharing site, when exporting digital photos, and/or when otherwise transmitting digital photos from a computing device). For example, privacy options can be provided to remove geographical location, if present, from digital photos when shared or to generalize geographical location for digital photos when shared.

Geographical location can be managed when taking digital photos. For example, when a digital photo is taken by a computing device, the current geographical location of the computing device can be determined (e.g., latitude and longitude can be obtained from a GPS receiver). Based on the current geographical location, a comparison can be made to sensitive geographical areas (e.g., one or more areas previously defined by a user). If the current geographical location is within one of the sensitive geographical areas, then appropriate action can be taken based on various privacy settings. In some implementations, the current geographical location is modified for inclusion in photo meta-data. For example, the modification can comprise removing or not including the current geographical location in the photo meta-data. The modification can also comprise including a generalized geographical location (e.g., a specific location outside the sensitive geographical areas) in the photo meta-data. If, on the other hand, the current geographical location is outside the sensitive geographical areas, different action can be taken. For example, the current geographical location can be included in digital photos (e.g., in meta-data associated with the digital photos) taken outside the sensitive geographical areas.

Geographical location can be stored in association with digital photos (e.g., in the same file and/or separately). In some implementations, geographical location (e.g., comprising longitude, and/or altitude) is stored in photo meta-data in a particular meta-data format. One example of a meta-data format that can store geographical location is the Exchangeable image file format (Exif), which is defined by a standard prepared by the Camera & Imaging Products Association (CIPA DC-008-2012).

The operations for managing geographical location when taking or sharing digital photos can be automatically performed without any user intervention (e.g., without the user having to manually edit photos to remove or alter location information). For example, a computing device can automatically determine the current geographical location (e.g., using a GPS receiver), automatically compare the current geographical location to sensitive geographical areas, automatically decide whether to include the current geographical location or a generalized geographical location in the digital photos (e.g., based on various system-defined and/or user-defined privacy options), and automatically save the digital photos with the determined geographical location (e.g., the current location, a generalized location, or with no geographical location information). The computing device can also automatically perform such operations when sharing digital photos.

### User Interfaces for Setting Privacy Options and Creating Sensitive Geographical Areas

In the technologies described herein, sensitive geographical areas can be created and privacy options can be configured. For example graphical user interfaces and associated user interface controls can be provided for creating sensitive geographical areas and setting privacy options used to manage geographical location of digital photos.

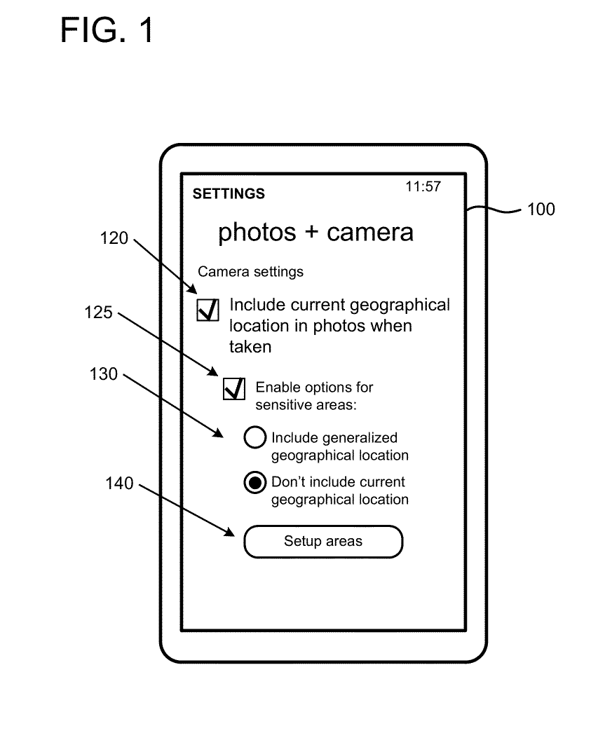

FIG. 1 depicts an example user interface 100 for setting privacy options for digital photos. As depicted in the example user interface 100, an option 120 is provided to include the current geographical location when taking digital photos. The option 120 can be a default or global option that turns geographical location for digital photos on or off for the device (e.g., to enable or disable the possibility of including the current geographical location) unless a more specific setting applies (e.g., as an override). In some implementations such as the one depicted in the example user interface 100, the option 120 is user-selectable, and if selected provides additional options (e.g., as depicted at 125 and 130). In other implementations, the option 120 is not present (e.g., a system-defined default can be provided to include, or not include, geographical location in photos when taken).

As depicted in the example user interface 100, a selection is provided to enable privacy options for sensitive areas 125. Enabling privacy options for sensitive areas can allow the user to select the privacy options depicted at 130 and setup sensitive geographical areas as depicted at 140.

As depicted in the example user interface 100, a number of privacy options are depicted at 130 for managing geographical location for digital photos taken within sensitive areas. The specific privacy options depicted at 130 are an option to include a generalized geographical location instead of the current location, and an option to not include the current geographical location. Other privacy options can be provided at 130 in addition to, or instead of, the particular privacy options depicted. For example, an additional privacy option can be provided to include the current geographical location. In some implementations, the privacy options depicted at 130 are displayed upon selection of option 120 and/or 125. In other implementations, the privacy options depicted at 130 can be provided independent of option 120 and/or 125. For example, the option to enable privacy options for sensitive areas 125 may not be present (e.g., the privacy options depicted at 130 may only be used when sensitive areas have been created at 140).

Also depicted in the example user interface 100 is a user interface element 140 for setting up sensitive geographical areas. Using the user interface element 140, the user can create one or more sensitive geographical areas to which the privacy options depicted at 130 will apply.

Changing privacy options, such as the privacy options depicted at 130, can result in the new privacy options being applied not just to digital photos when taken but to existing digital photos as well (e.g., digital photos that have already been taken and stored on the computing device, such as in a photo library or camera roll). For example, a user could use the user interface 100 to configure privacy settings to not include the current geographical location for digital photos taken within a sensitive geographical area encompassing the user's home address. Upon configuring the privacy setting, the user interface 100 can display an option to apply the new setting to existing photos (e.g., to apply the new setting retroactively to all existing photos or only to selected existing photos, such as photos in specific albums, on a photo-by-photo basis, or based on some other type of selection). By selecting the option, any stored digital photos with a geographical location within the sensitive geographical area encompassing the user's home address can be modified to remove the geographical location (e.g., by removing location information from photo meta-data for the stored digital photos).

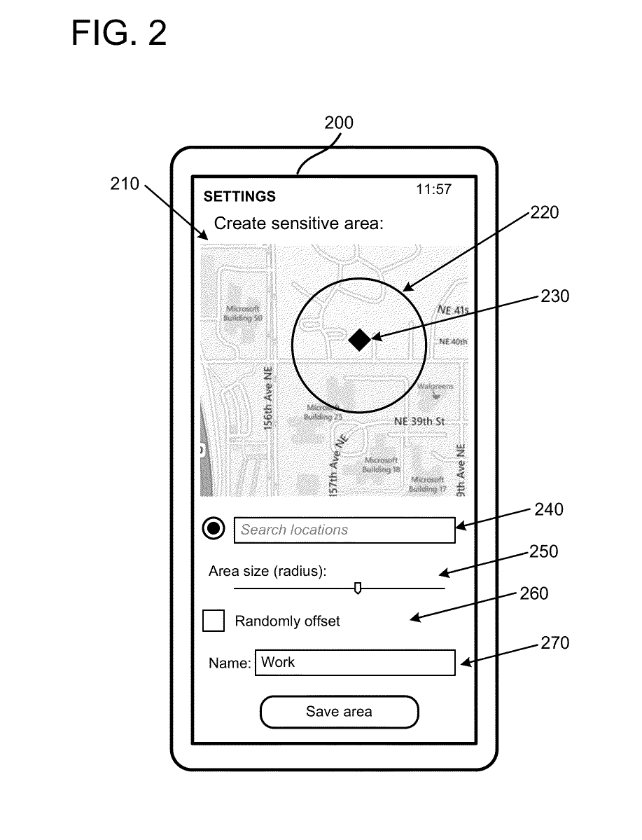

FIG. 2 depicts an example user interface 200 for creating sensitive geographical areas. For example, the user interface 200 can be displayed is response to selection of the user interface element 140 depicted in FIG. 1.

A sensitive geographical area refers to any type of geographical area created for managing geographical location information for digital photos. For example, a user can create one or more sensitive geographical areas to control the geographical location of digital photos taken within those geographical areas. For example, the user can setup separate sensitive geographical areas for different locations (e.g., work, home, and/or other locations).

As depicted in the example user interface 200, a map 210 is displayed along with a sensitive geographical area 220. The sensitive geographical area 220, which is a circle in this example, is defined by a location 230 and a radius. The location 230 can be designated, for example, by an address (e.g., entered using the location field 240), by entering longitude and latitude information, by selecting a point on the map 210 (e.g., by the user tapping on the map to indicate the location), etc.

The size of the sensitive geographical area 220 can be defined using a radius. As depicted in the example user interface 200, a radius slider 250 is provided for a user to select a desired radius for the sensitive geographical area 220. Different user interface controls can also be provided for entering the radius (e.g., an entry field, a drop-down list of pre-defined values, etc.).

The example user interface 200 for creating sensitive geographical areas also includes a user interface element 260 for randomly offsetting the sensitive geographical area 220. Selecting the user interface element 260 can cause the sensitive geographical area 220 to be offset from the originally created area. Offsetting the sensitive geographical area 220 can be accomplished, for example, by randomly moving the area 220. The offsetting can be performed so that the original location entered by the user (e.g., location 230) is still within the sensitive geographical area after the offset has been performed (e.g., the offset can be performed so that the location entered or selected by the user is no longer located at or near the center of the area after it has been moved).

The example user interface 200 includes a user interface element 270 for entering a name for the sensitive geographical area. The name can be used to identify the sensitive geographical area when saved (e.g., saved using the “save area” user interface element). Using the example user interface 200, a number of sensitive geographical areas can be created by the user and saved using different names (e.g., work, home, school, etc.).

The size and dimensions of the sensitive geographical area can be defined using a shape other than a circle. For example, the sensitive geographical area can be defined using a square, rectangle, triangle, or another shape. The size can be defined in a variety of ways, such as by using entry fields (e.g., length and width or area), using sliders, by resizing the outline of the shape using a touch screen display, or in other ways. In a specific implementation, a number of pre-defined geographical area sizes are provided (e.g., as a drop-down list for selection by the user). For example, the pre-defined geographical area sizes could be specific sizes (e.g., representing radius or diameter), such as: quarter mile, half mile, mile, 5 miles. The pre-defined geographical area sizes could be defined in other terms, such as: block, neighborhood, and city.

In some implementations, a minimum and/or maximum size can be enforced for the sensitive geographical area. For example, a minimum size of one-quarter mile can be enforced (e.g., to provide a minimum level of privacy). In some implementations, a default size can be provided (e.g., as an initial size, which can be adjusted by the user). For example, the default size can be pre-defined (e.g., one-half mile) or can vary depending on various criteria, such as the population density of the area (e.g., the default size can be smaller for a higher density area and larger for a lower density area).

In some implementations, sensitive geographical areas can be determined. For example, the computing device can automatically determine sensitive locations based on address information (e.g., the user's home address, work address, school address, etc.), based on location of the device at various times (e.g., if the device is in the same location most nights, then that location can be determined to be the user's home, and similarly if the device is in the same location during work hours, then that location can be determined to be the user's work), and/or based on location information determined from other sources (e.g., from information services running on the device and/or external to the device). Based on the automatically determined sensitive geographical areas, the computing device can automatically create one or more sensitive geographical areas (e.g., at the direction of the user or without user direction). The automatically determined sensitive geographical areas can also be used as suggestions when the user is creating sensitive geographical areas (e.g., automatically determined home and work areas can be provided for selection by the user).

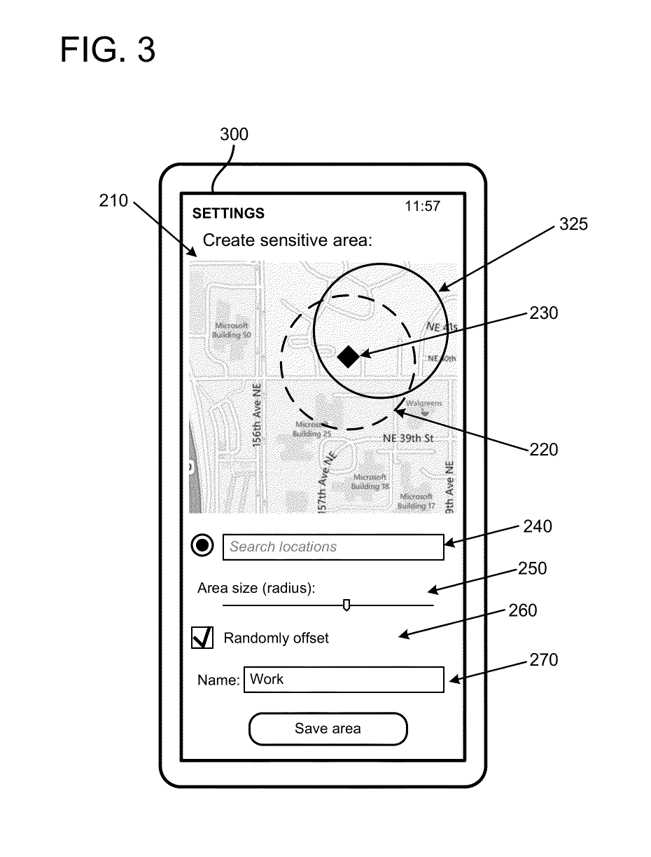

FIG. 3 depicts an example user interface 300 for creating a sensitive geographical area with a random offset. In the example user interface 300, the user interface element 260 for randomly offsetting the sensitive geographical area has been selected. In response, sensitive geographical area 220 has been randomly offset to the new sensitive geographical area 325. The random offset can be performed, for example, by randomly offsetting the location 230 of the sensitive geographical area, thus moving the area from the original area 220 to the new area 325. The random offset operation can be performed while keeping the original location 230 within the boundary of the offset area 325.

Providing a random offset for the sensitive geographical area can provide additional privacy. For example, a user may select the location (e.g., location 230) by entering the user's home address. If the user's home address is at the center of the sensitive geographical area, then it may be possible for a third party to identify the location (e.g., by analyzing location information for pictures near, but outside, the boundary of the area). In order to provide additional privacy for the location entered by the user, the user can select an option to randomly offset the area so that the location entered by the user (e.g., the user's home address) is no longer at or near the center of the sensitive geographical area.

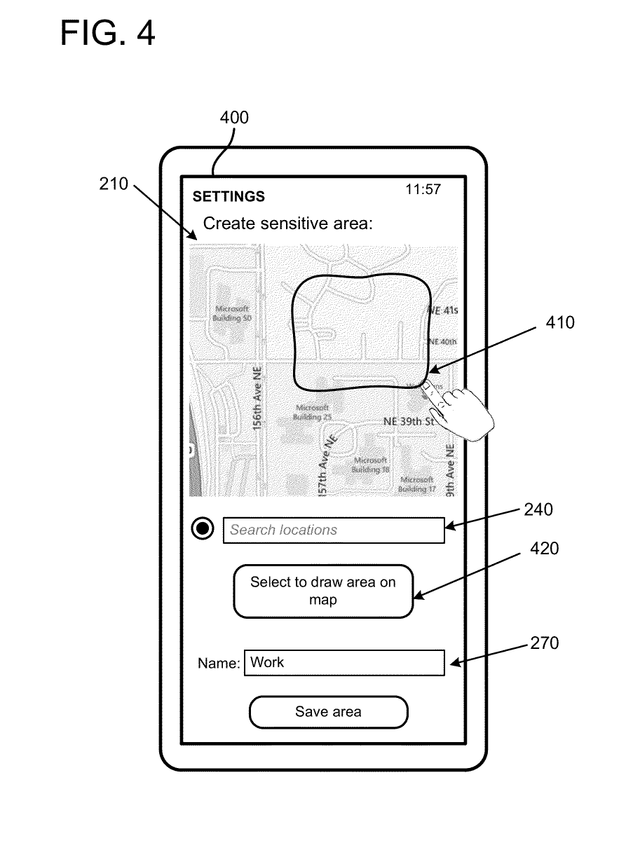

FIG. 4 depicts an example user interface 400 for creating a sensitive geographical area using a free-form drawing tool. For example, the example user interface 400 can provide an alternative in addition to creating the sensitive geographical area using a location and radius, as depicted in FIG. 2. In some implementations, the free-form entry tool can be the only available option to create sensitive geographical areas (e.g., the free-form entry tool can create a sensitive geographical area that is harder to detect than a point and radius).

In the example user interface 400, a free-form drawing tool is provided where a user can create a sensitive geographical area by drawing a shape on the map 210. As depicted in the example user interface 400, the user has drawn the sensitive geographical area 410 using the user's finger. The sensitive geographical area 410 is in the general form of a rectangle, but other shapes could be drawn as well.

Using the free-form drawing tool, the user can draw the boundary of the sensitive geographical area (e.g., area 410) without having to enter a specific location. Alternatively, the user could select a specific location (e.g., using the location field 240), which may be helpful in identifying the location (e.g., home address) the user wants to include in the sensitive geographical area.

In some implementations, a user interface element 420 is provided for selection by the user prior to using the free-form drawing tool to create the sensitive geographical area. For example, the user interface element 420 can lock out map controls (e.g., selecting, panning, zooming, etc.) so that the map controls do not interfere with the user drawing the boundary of the sensitive geographical area on the map.

In some implementations, the free-form drawing tool supports an arbitrary shape drawn by the user. In other implementations, the free-form drawing tool enforces some restraints on the shape of the area (e.g., allowing the user to draw a specific shape, such as a square or rectangle, by tapping to select the start location and dragging over the map to select the size using a touch screen).

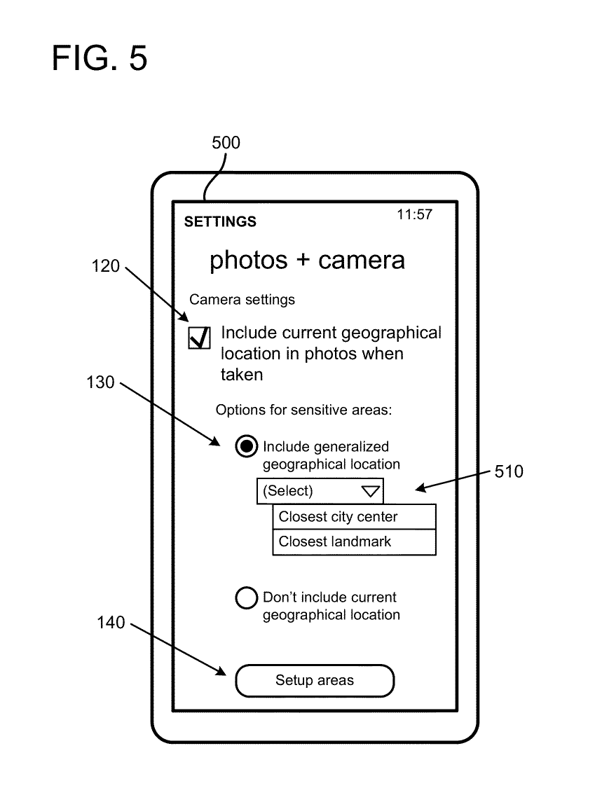

FIG. 5 depicts an example user interface 500 for setting privacy options for digital photos including use of a generalized geographical location. For example, the example user interface 500 can be displayed when a user selects the “Include generalized geographical location” option from the list of privacy options displayed at 130.

In the implementation depicted in the example user interface 500, selecting to include a generalized geographical location brings up a list of generalized geographical location options 510. The user can then select one of the generalized geographical location options 510 to use instead of the current location when taking photos within sensitive geographical areas. For example, a user can create a sensitive geographical area and select the privacy option to include a generalized geographical location for digital photos taken within the sensitive geographical area and select one of the generalized geographical location options 510. For example, if the user selects “Closest city center,” then digital photos taken by the user within the sensitive geographical area will be associated with (e.g., stored in photo meta-data with the digital photo) a geographical location corresponding to the city center of the closest city to the current location (e.g., specific longitude and latitude values that are associated with the closest city center). For example, if the user takes a photo near the user's home in the city of Redmond, Wash., then a generalized geographical location of the city center for the city of Redmond, Wash. can be used.

In some implementations, a user can select an arbitrary location (e.g., a point on a map, a landmark, a waypoint, etc.) as a generalized geographical location. For example, the user could be presented with a map for indicating (e.g., by tapping on the map) a generalized geographical location to use for digital photos taken within a sensitive geographical area.

In some implementations, the user does not have to select a generalized geographical location option (e.g., the generalized geographical location options 510 may not be present). For example, if the user selects the privacy option to include a generalized geographical location, then the device can automatically select a generalized location to use (e.g., a nearby city center or landmark from a pre-defined list, a random non-residential location, etc.).

Using a generalized geographical location can provide additional privacy while still maintaining some indication of the geographical location where digital photos are taken. For example, a user may not want digital photos taken near the user's home to include the geographical location where the photos were taken. However, the user may still want to know the general area where the digital photos were taken (e.g., when viewing on a map). Therefore, the user can select to use a generalized geographical location of the closest city center for digital photos taken close to the user's home (e.g., as defined by a sensitive geographical area created by the user).

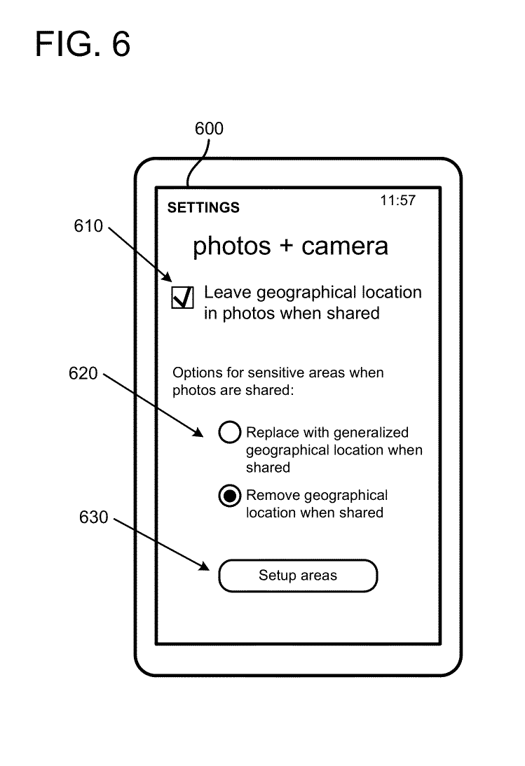

FIG. 6 depicts an example user interface 600 for setting privacy options for use when sharing digital photos (e.g., when emailing, sending in an instant message, uploading to a sharing site, or otherwise transmitting to another device) for sensitive geographical areas. As depicted in the example user interface 600, an option 610 is provided to leave geographical location in digital photos when shared (to retain the current geographical location, if any, associated with the digital photos). The option 610 can be a default or global option that will be used unless a more specific setting applies (e.g., as an override). In some implementations such as the one depicted in the example user interface 600, the option 610 is user-selectable, and if selected provides additional options (e.g., as depicted at 620). In other implementations, the option 610 is not present (e.g., a system-defined default can be provided to leave, or remove, geographical location in digital photos when shared).

As depicted in the example user interface 600, a number of privacy options are depicted at 620 for managing geographical location information for digital photos when shared with locations in sensitive geographical areas. The specific privacy options depicted at 620 are an option to include a generalized geographical location instead of the location currently associated (e.g., currently stored in photo meta-data), and an option to remove the geographical location associated with the digital photos (e.g., currently stored in photo meta-data). Other privacy options can also be provided, such as a default option to apply to digital photos when shared when the digital photos are not within a sensitive area (e.g., to leave geographical location in place, to replace with a generalized geographical location, or to remove geographical location).

Also depicted in the example user interface 600 is a user interface element 630 for setting up sensitive geographical areas for the selected privacy options 620. The user interface element 630 can operate in the same manner as the user interface element 140. In some implementations, the same sensitive geographical areas can be used for both taking photos and sharing photos. In other implementations, separate sensitive geographical areas can be created for taking photos and sharing photos.

For example, the privacy options to apply when sharing digital photos (e.g., as depicted at 620) can be applied by software (e.g., application and/or operating system software) of a computing device (e.g., a mobile phone or tablet). For example, a photo sharing application that automatically uploads digital photos to a photo storage/sharing site can apply the privacy options prior to uploading the digital photos (e.g., to remove geographical location for sensitive geographical areas created by the user of the device). As another example, privacy options can be applied at the operating system level or file system level (e.g., via a file system driver), such as when a mobile phone is connected to another computing device via a USB cable and operates as an external storage device.

The privacy options 130 depicted in FIG. 1 and the privacy options 620 depicted in FIG. 6 can be used separately or in combination. For example, a user can use one set of privacy settings (e.g., as depicted at 130) to manage location information for digital photos when the digital photos are taken (e.g., at the time the digital photos are taken and saved). The user can use another set of privacy settings (e.g., as depicted at 620) to manage location information for digital photos when the digital photos are shared. The user can apply similar privacy settings, or different privacy settings, for each situation.

A user can create a number of sensitive geographical areas and associate individual sensitive geographical areas with different privacy options. For example, a user can create a first sensitive geographical area for the user's home and assign a specific privacy option (e.g., to not include current geographical location when taking digital photos within the first sensitive geographical area). The user can create a second sensitive geographical area for the user's work and assign a specific privacy option (e.g., to include a generalized geographical location when taking digital photos within the second sensitive geographical area). The user can also assign privacy options to take effect when previously taken digital photos (e.g., digital photos stored on the device) are shared. For example, the user can assign a privacy option to remove the geographical location for any digital photos when shared that have a geographical location within a sensitive geographical area for the user's home.

The user interfaces depicted in FIGS. 1-6 can be displayed by a computing device, such as a mobile phone, tablet, camera, laptop, desktop, or another type of computing device. In some implementations, the computing device is a mobile computing device with a camera and a GPS receiver (e.g., a phone or tablet with an integrated camera and GPS receiver or a stand-alone camera with a GPS receiver).

In some implementations, geographical location is stored in photo meta-data that is associated with corresponding digital photos (e.g., stored along with digital photo data in the same file or stored separately and associated with the digital photo). For example, geographical location can be stored using the Exif meta-data format.

### Methods for Managing Geographical Location for Digital Photos

In any of the examples herein, methods can be provided for managing geographical location of digital photos. Geographical location of digital photos can be managed when the digital photos are taken and/or when the digital photos are shared. For example, when a digital photo is taken (e.g., when the user takes a picture with the user's smart phone) a number of privacy options can be evaluated to determine whether to include the current location of the computing device taking the photo with the photo (e.g., store the location information in photo meta-data), not include the current location (e.g., so there is no location information stored in the photo meta-data), or store a generalized location in place of the current location.

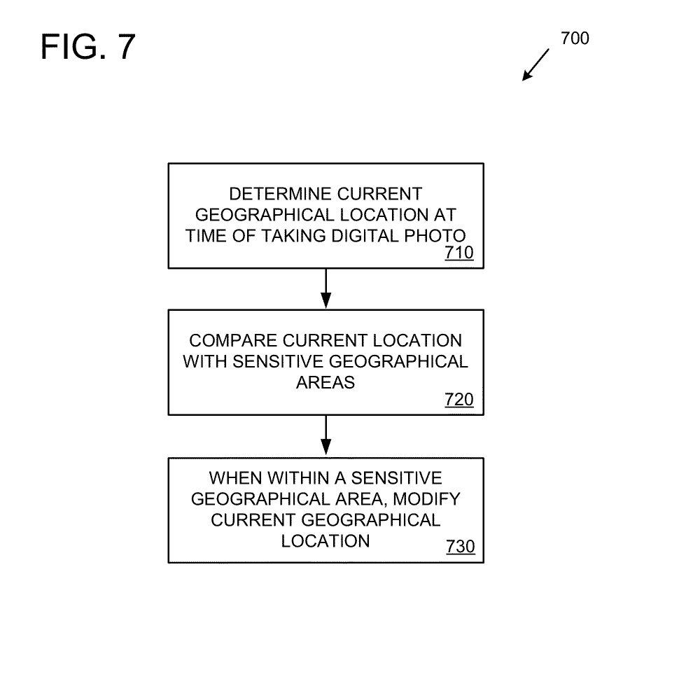

FIG. 7 is a flowchart of an example method 700 for managing geographical location of digital photos. The example method 700 can be performed, at least in part, by a computing device.

At 710, the current geographical location is determined at the time of taking a digital photo (e.g., contemporaneous with taking and saving the digital photo). For example, the current geographical location can be determined when a user takes a digital photo with a computing device that has a digital camera (e.g., a smart phone or tablet with a built-in camera, a standalone camera, and/or another type of computing device). The current geographical location can comprise latitude and longitude geographical location information. Additional information related to position and/or movement can also be included in the geographical location information (e.g., altitude, direction or compass information, speed, etc.).

At 720, the current geographical location (determined at 710) is compared with one or more sensitive geographical areas. The sensitive geographical areas can be created by a user using a graphical user interface, such as the graphical user interface depicted in FIG. 2. Comparing the current geographical location with the one or more sensitive geographical areas can comprise determining whether the current geographical location is within any of the one or more sensitive geographical areas. The current geographical location can be determined, for example, using GPS information.

At 730, when the current geographical location is within at least one of the one or more sensitive geographical areas, then the current geographical location is modified. Modifying the current geographical location can comprise removing or generalizing the current geographical location (e.g., as controlled by one or more privacy options, which can be system-defined options and/or user-defined options) when it is associated with the digital photo (e.g., when it is added to photo meta-data, such as Exif meta-data, for the digital photo and stored). If the current geographical location is removed, then the digital photo can be saved without being associated with the current geographical location (e.g., without any geographical location information in photo-meta data for the digital photo). If the current geographical location is generalized, then a generalized geographical location can be saved with the digital photo instead of the current location. For example, the generalized geographical location can be determined (e.g., determined based on a previously configured setting, determined dynamically based on a nearby city center or landmark, etc.) and the determined generalized geographical location can then be saved in place of the current geographical location.

If, however, the current geographical location is outside the one or more sensitive geographical areas, then the digital photo can be saved with the current geographical location. For example, the current geographical location can be saved in photo-meta data (e.g., in the Exif format) for the digital photo.

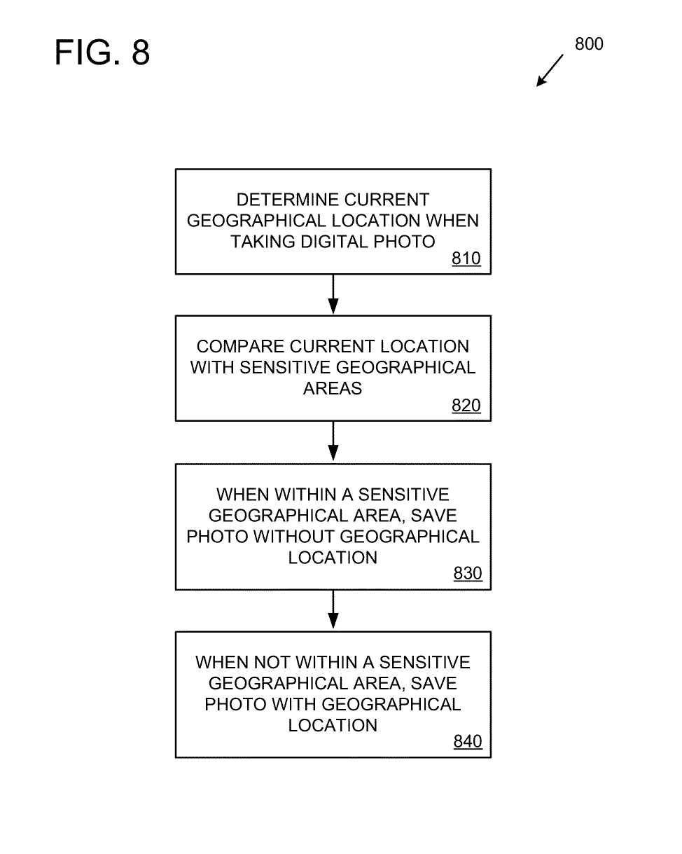

FIG. 8 is a flowchart of an example method 800 for managing geographical location of digital photos when inside and when outside sensitive geographical areas. The example method 800 can be performed, at least in part, by a computing device.

At 810, the current geographical location is determined when taking a digital photo (e.g., when the digital photo is taken and saved). For example, the current geographical location can be determined when a user takes a digital photo with a computing device that has a digital camera (e.g., a smart phone or tablet with a built-in camera, a standalone camera, and/or another type of computing device). The current geographical location can comprise latitude and longitude geographical location information. Additional information related to position and/or movement can also be included in the geographical location information (e.g., altitude, direction or compass information, speed, etc.).

At 820, the current geographical location (determined at 810) is compared with one or more sensitive geographical areas. The sensitive geographical areas can be created by a user using a graphical user interface, such as the graphical user interface depicted in FIG. 2. Comparing the current geographical location with the one or more sensitive geographical areas can comprise determining whether the current geographical location is within any of the one or more sensitive geographical areas, or whether the current geographical location is outside all of the one or more sensitive geographical areas. The current geographical location can be determined, for example, using GPS information.

At 830, when the current geographical location is within at least one of the one or more sensitive geographical areas, the digital photo is saved without the current geographical location (e.g., without any geographical location information in photo-meta data for the digital photo). Alternatively, the current geographical location can be replaced with a generalized geographical location (e.g., depending on configuration of privacy options). At 840, when the current geographical location is not within any of the one or more sensitive geographical areas, the digital photo is saved with the current geographical location (e.g., with the current geographical location in photo meta-data for the digital photo).

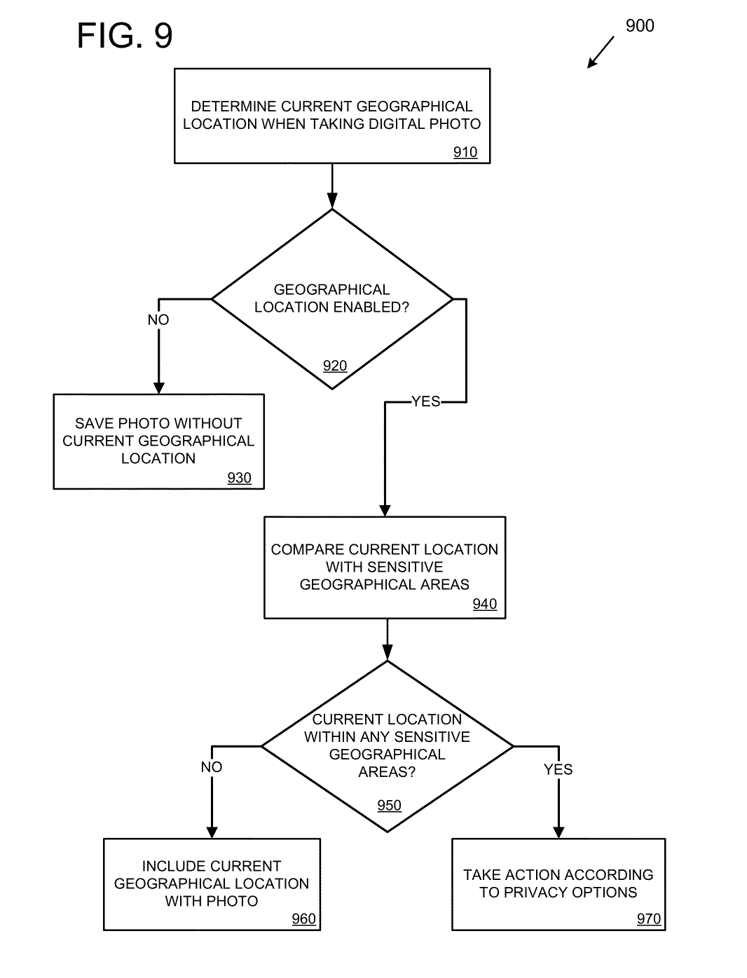

FIG. 9 is a flowchart of an example method 900 for managing geographical location of digital photos according to privacy options. The example method 900 can be performed, at least in part, by a computing device.

At 910, the current geographical location is determined when taking a digital photo (e.g., when the digital photo is taken and saved). The current geographical location can comprise latitude and longitude geographical location information. Alternatively, the current geographical location can be determined after a determination has been made that geographical location is enabled (e.g., after 920 and before 940).

At 920 a determination is made whether geographical location is enabled for digital photos. The determination can comprise checking one or more privacy options, such as a default privacy option setting for enabling (or disabling) inclusion of current geographical location in digital photos when taken. For example, the privacy option can be the privacy option depicted at 120.

If geographical location is not enabled (e.g., as a default setting), then the method proceeds to 930 and the digital photo is saved without the current geographical information. However, if geographical location is enabled for digital photos (e.g., as a default setting), then the method proceeds to 940 where the current geographical location is compared with one or more sensitive geographical areas.

At 950, a determination is made whether the current geographical location is within any of the one or more sensitive geographical areas. If the current geographical location is not within any of the one or more sensitive geographical areas, then the method proceeds to 960 where the current geographical location is included in the digital photo (e.g., included in photo meta-data with the saved digital photo).

If the current geographical location is within at least one of the one or more sensitive geographical areas, then the method proceeds to 970 where action is taken according to privacy options for handling geographical location for digital photos taken within a sensitive geographical area (e.g., privacy options such as those depicted at 130). For example, if a privacy option is set to include a generalized geographical location, then the digital photo can be saved with a generalized geographical location instead of the current geographical location. If a privacy option is set to not include the current geographical location, then the digital photo can be saved without the current geographical location, and without any geographical location (e.g., with photo meta-data having empty location information fields). Action can also be taken depending on the specific sensitive geographical area (or areas) within which the current geographical location is located (e.g., different privacy options can apply to different sensitive geographical areas).

### Example Implementations for Photo Services

Any of the technologies described herein for managing geographical location for digital photos can be applied in a photo service setting. For example, a photo service setting can include a photo sharing web site, a photo storage site (e.g., a backup service), or another service (e.g., web service) where digital photos are stored or accessed.

For example, geographical location can be managed when digital photos are uploaded and/or accessed (e.g., viewed or downloaded) from the photo service. For example, sensitive geographical areas can be created (e.g., by a user using the photo service, uploaded from the user's device, etc.). In addition, privacy options can be set (e.g., by the user using the photos service, uploaded from the user's device, etc.). When digital photos are uploaded and/or accessed, geographical location can be managed according to the privacy options and/or sensitive geographical areas.

Additional privacy options can be provided based on users and/or groups. For example, a user may only want specific people or groups of people (e.g., friends and family) to be able to view or access the geographical location of digital photos stored on a photo site. According to the privacy options set by the user, friends and family may be able to view and/or access the digital photos with the geographical location, if any, stored in the digital photos (e.g., see the digital photos displayed on a map), while others may not be able to view or access the geographical location of the digital photos.

In a specific implementation, the following operations are performed for accessing (e.g., viewing or downloading) photos from a photo service.

1. Access photos from photo service, and conditionally provide geographical location information for accessed photos according to the following:
a. If the owner of the photos is accessing, location information (e.g., Exif location information) is included.
b. If another user is accessing, the location information is not included by default. Instead, privacy options are provided to the owner to give control over this setting to configure:
   1. Which other users may access/download images with location information included.
   2. Expiration of the privacy options (e.g., after a number of days, weeks, years, or another period of time).

### Computing Systems

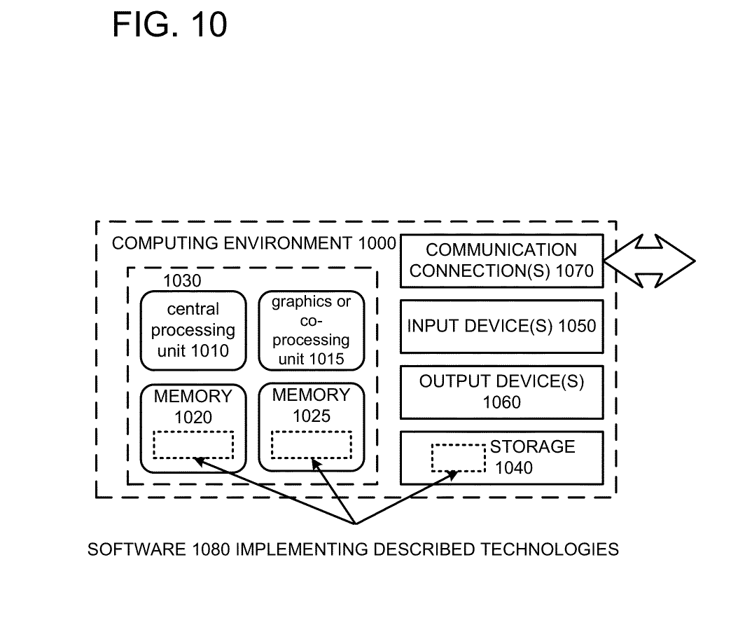

FIG. 10 depicts a generalized example of a suitable computing system 1000 in which the described innovations may be implemented. The computing system 1000 is not intended to suggest any limitation as to scope of use or functionality, as the innovations may be implemented in diverse general-purpose or special-purpose computing systems.

With reference to FIG. 10, the computing system 1000 includes one or more processing units 1010, 1015 and memory 1020, 1025. In FIG. 10, this basic configuration 1030 is included within a dashed line. The processing units 1010, 1015 execute computer-executable instructions. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 10 shows a central processing unit 1010 as well as a graphics processing unit or co-processing unit 1015. The tangible memory 1020, 1025 may be volatile memory (e.g., registers, cache, RAM), non-volatile memory (e.g., ROM, EEPROM, flash memory, etc.), or some combination of the two, accessible by the processing unit(s). The memory 1020, 1025 stores software 1080 implementing one or more innovations described herein, in the form of computer-executable instructions suitable for execution by the processing unit(s).

A computing system may have additional features. For example, the computing system 1000 includes storage 1040, one or more input devices 1050, one or more output devices 1060, and one or more communication connections 1070. An interconnection mechanism (not shown) such as a bus, controller, or network interconnects the components of the computing system 1000. Typically, operating system software (not shown) provides an operating environment for other software executing in the computing system 1000, and coordinates activities of the components of the computing system 1000.

The tangible storage 1040 may be removable or non-removable, and includes magnetic disks, magnetic tapes or cassettes, CD-ROMs, DVDs, or any other medium which can be used to store information and which can be accessed within the computing system 1000. The storage 1040 stores instructions for the software 1080 implementing one or more innovations described herein.

The input device(s) 1050 may be a touch input device such as a keyboard, mouse, pen, or trackball, a voice input device, a scanning device, or another device that provides input to the computing system 1000. For video encoding, the input device(s) 1050 may be a camera, video card, TV tuner card, or similar device that accepts video input in analog or digital form, or a CD-ROM or CD-RW that reads video samples into the computing system 1000. The output device(s) 1060 may be a display, printer, speaker, CD-writer, or another device that provides output from the computing system 1000.

The communication connection(s) 1070 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Mobile Device

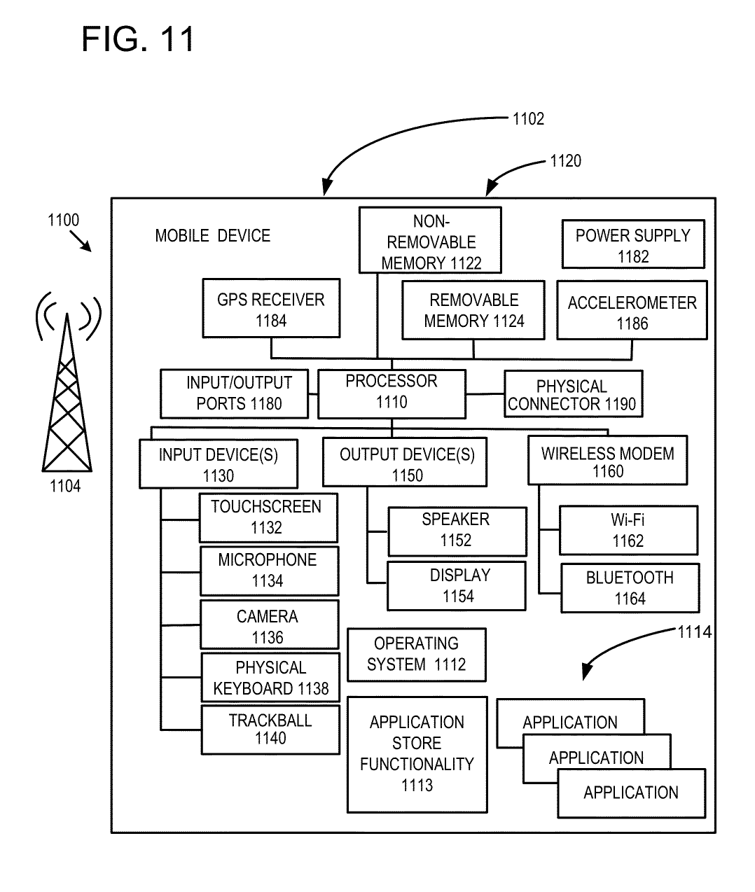

FIG. 11 is a system diagram depicting an example mobile device 1100 including a variety of optional hardware and software components, shown generally at 1102. Any components 1102 in the mobile device can communicate with any other component, although not all connections are shown, for ease of illustration. The mobile device can be any of a variety of computing devices (e.g., cell phone, smartphone, handheld computer, Personal Digital Assistant (PDA), etc.) and can allow wireless two-way communications with one or more mobile communications networks 1104, such as a cellular, satellite, or other network.

The illustrated mobile device 1100 can include a controller or processor 1110 (e.g., signal processor, microprocessor, ASIC, or other control and processing logic circuitry) for performing such tasks as signal coding, data processing, input/output processing, power control, and/or other functions. An operating system 1112 can control the allocation and usage of the components 1102 and support for one or more application programs 1114. The application programs can include common mobile computing applications (e.g., email applications, calendars, contact managers, web browsers, messaging applications), or any other computing application. Functionality 1113 for accessing an application store can also be used for acquiring and updating application programs 1114.

The illustrated mobile device 1100 can include memory 1120. Memory 1120 can include non-removable memory 1122 and/or removable memory 1124. The non-removable memory 1122 can include RAM, ROM, flash memory, a hard disk, or other well-known memory storage technologies. The removable memory 1124 can include flash memory or a Subscriber Identity Module (SIM) card, which is well known in GSM communication systems, or other well-known memory storage technologies, such as “smart cards.” The memory 1120 can be used for storing data and/or code for running the operating system 1112 and the applications 1114. Example data can include web pages, text, images, sound files, video data, or other data sets to be sent to and/or received from one or more network servers or other devices via one or more wired or wireless networks. The memory 1120 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The mobile device 1100 can support one or more input devices 1130, such as a touchscreen 1132, microphone 1134, camera 1136, physical keyboard 1138 and/or trackball 1140 and one or more output devices 1150, such as a speaker 1152 and a display 1154. Other possible output devices (not shown) can include piezoelectric or other haptic output devices. Some devices can serve more than one input/output function. For example, touchscreen 1132 and display 1154 can be combined in a single input/output device.

The input devices 1130 can include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 1112 or applications 1114 can comprise speech-recognition software as part of a voice user interface that allows a user to operate the device 1100 via voice commands. Further, the device 1100 can comprise input devices and software that allows for user interaction via a user's spatial gestures, such as detecting and interpreting gestures to provide input to a gaming application.

A wireless modem 1160 can be coupled to an antenna (not shown) and can support two-way communications between the processor 1110 and external devices, as is well understood in the art. The modem 1160 is shown generically and can include a cellular modem for communicating with the mobile communication network 1104 and/or other radio-based modems (e.g., Bluetooth 1164 or Wi-Fi 1162). The wireless modem 1160 is typically configured for communication with one or more cellular networks, such as a GSM network for data and voice communications within a single cellular network, between cellular networks, or between the mobile device and a public switched telephone network (PSTN).

The mobile device can further include at least one input/output port 1180, a power supply 1182, a satellite navigation system receiver 1184, such as a Global Positioning System (GPS) receiver, an accelerometer 1186, and/or a physical connector 1190, which can be a USB port, IEEE 1394 (FireWire) port, and/or RS-232 port. The illustrated components 1102 are not required or all-inclusive, as any components can be deleted and other components can be added.

### Cloud-Supported Environment

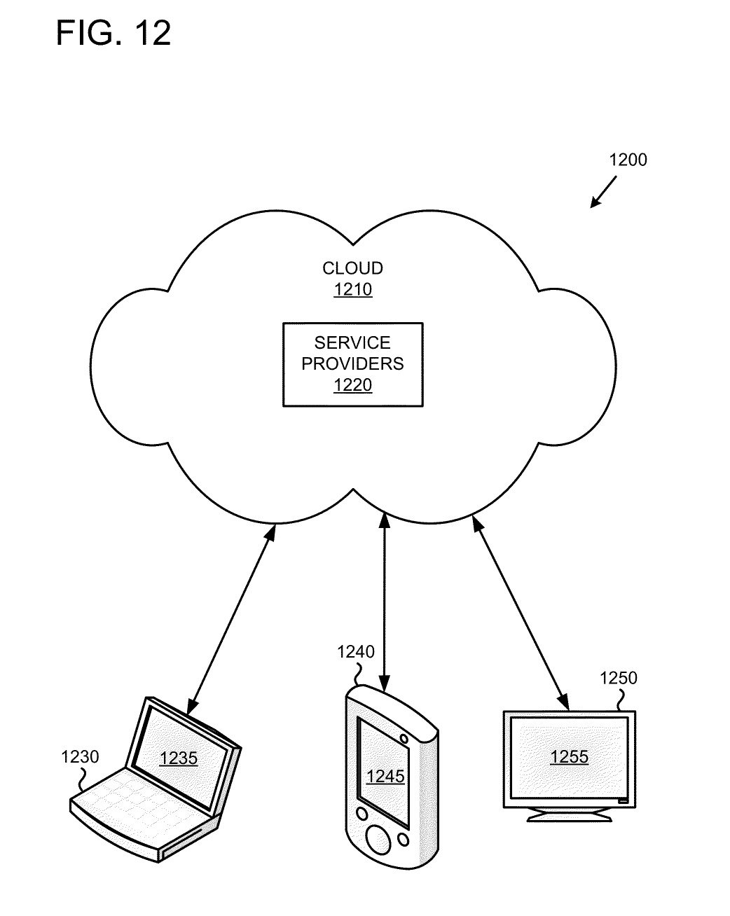

FIG. 12 illustrates a generalized example of a suitable cloud-supported environment 1200 in which described embodiments, techniques, and technologies may be implemented. In the example environment 1200, various types of services (e.g., computing services) are provided by a cloud 1210. For example, the cloud 1210 can comprise a collection of computing devices, which may be located centrally or distributed, that provide cloud-based services to various types of users and devices connected via a network such as the Internet. The implementation environment 1200 can be used in different ways to accomplish computing tasks. For example, some tasks (e.g., processing user input and presenting a user interface) can be performed on local computing devices (e.g., connected devices 1230, 1240, 1250) while other tasks (e.g., storage of data to be used in subsequent processing) can be performed in the cloud 1210.

In example environment 1200, the cloud 1210 provides services for connected devices 1230, 1240, 1250 with a variety of screen capabilities. Connected device 1230 represents a device with a computer screen 1235 (e.g., a mid-size screen). For example, connected device 1230 could be a personal computer such as desktop computer, laptop, notebook, netbook, or the like. Connected device 1240 represents a device with a mobile device screen 1245 (e.g., a small size screen). For example, connected device 1240 could be a mobile phone, smart phone, personal digital assistant, tablet computer, and the like. Connected device 1250 represents a device with a large screen 1255. For example, connected device 1250 could be a television screen (e.g., a smart television) or another device connected to a television (e.g., a set-top box or gaming console) or the like. One or more of the connected devices 1230, 1240, 1250 can include touchscreen capabilities. Touchscreens can accept input in different ways. For example, capacitive touchscreens detect touch input when an object (e.g., a fingertip or stylus) distorts or interrupts an electrical current running across the surface. As another example, touchscreens can use optical sensors to detect touch input when beams from the optical sensors are interrupted. Physical contact with the surface of the screen is not necessary for input to be detected by some touchscreens. Devices without screen capabilities also can be used in example environment 1200. For example, the cloud 1210 can provide services for one or more computers (e.g., server computers) without displays.

Services can be provided by the cloud 1210 through service providers 1220, or through other providers of online services (not depicted). For example, cloud services can be customized to the screen size, display capability, and/or touchscreen capability of a particular connected device (e.g., connected devices 1230, 1240, 1250).

In example environment 1200, the cloud 1210 provides the technologies and solutions described herein to the various connected devices 1230, 1240, 1250 using, at least in part, the service providers 1220. For example, the service providers 1220 can provide a centralized solution for various cloud-based services. The service providers 1220 can manage service subscriptions for users and/or devices (e.g., for the connected devices 1230, 1240, 1250 and/or their respective users).

### Example Implementations

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media and executed on a computing device (e.g., any available computing device, including smart phones or other mobile devices that include computing hardware). Computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example and with reference to FIG. 10, computer-readable storage media include memory 1020 and 1025, and storage 1040. By way of example and with reference to FIG. 11, computer-readable storage media include memory and storage 1120, 1122, and 1124. The term computer-readable storage media does not include signals and carrier waves. In addition, the term computer-readable storage media does not include communication connections (e.g., 1070, 1160, 1162, and 1164).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. A method, implemented at least in part by a computing device, for managing geographical location of digital photos, the method comprising:
at a time of taking a digital photo:
determining a current geographical location of the computing device, wherein the current geographical location comprises geographical location information comprising longitude and latitude;
comparing the current geographical location of the computing device with one or more sensitive geographical areas; and
when the current geographical location of the computing device is within at least one of the one or more sensitive geographical areas:
modifying the current geographical location for inclusion in photo meta-data of the digital photo.

2. The method of claim 1 wherein modifying the current geographical location comprises:
saving the digital photo without the current geographical location, wherein the digital photo is saved without any geographical location information.

3. The method of claim 1 wherein modifying the current geographical location comprises:
generalizing the current geographical location to create a generalized geographical location; and
saving the digital photo with the generalized geographical location.

4. The method of claim 1 wherein modifying the current geographical location comprises:
determining a generalized geographical location;
replacing the current geographical location with the generalized geographical location; and
saving the digital photo with the generalized geographical location in the photo meta-data of the digital photo.

5. The method of claim 1 further comprising:
receiving, from a user of the computing device using a graphical user interface, indications of the one or more sensitive geographical areas.

6. The method of claim 1 wherein the current geographical location of the computing device is determined, at least in part, based on Global Positioning System (GPS) information obtained by the computing device.

7. The method of claim 1 further comprising:
when the current geographical location of the computing device is outside the one or more sensitive geographical areas:
saving the digital photo with the geographical location information indicating the current geographical location.

8. The method of claim 1 further comprising:
creating Exchangeable image file format (Exif) meta-data for the digital photo, the Exif meta-data comprising the modified geographical location; and
saving the digital photo with the Exif meta-data.

9. A computing device comprising:
a processing unit;
memory; and
a camera;
the computing device configured to perform operations for managing geographical location of digital photos, the operations comprising:
when taking a digital photo with the camera:
determining a current geographical location of the computing device, wherein the current geographical location comprises geographical location information comprising longitude and latitude of the computing device when the digital photo is taken;
comparing the current geographical location of the computing device with one or more sensitive geographical areas;
when the current geographical location of the computing device is within at least one of the one or more sensitive geographical areas:
saving the digital photo without the current geographical location, wherein the digital photo is saved without any geographical location information in photo meta-data of the digital photo; and
when the current geographical location of the computing device is outside the one or more sensitive geographical areas:
saving the digital photo with the geographical location information indicating the current geographical location in the photo meta-data of the digital photo.

10. The computing device of claim 9 the operations further comprising:
presenting a graphical user interface for creating sensitive geographical areas; and
receiving, from a user, indications of the one or more sensitive geographical areas via the graphical user interface.

11. The computing device of claim 9 further comprising:
a Global Positioning System (GPS) receiver;
wherein the current geographical location of the computing device is determined, at least in part, based on GPS information obtained from the GPS receiver.

12. A computer-readable storage medium storing computer-executable instructions for causing a computing device to perform a method for managing geographical location of digital photos, the method comprising:
providing first graphical user interface controls for creating sensitive geographical areas, the first graphical user interface controls configured to:
receive indications of one or more sensitive geographical areas from a user of the graphical user interface control;
providing second graphical user interface controls for setting privacy options related to digital photos taken within the sensitive geographical areas, the second graphical user interface controls configured to:
provide a privacy option to use a generalized geographical location, instead of current geographical location, in digital photos when taken; and
provide a privacy option to not include current geographical location in digital photos when taken; and
providing third graphical user interface controls for setting privacy options defining a default for including, or not including, current geographical location in digital photos when taken.

13. The computer-readable storage medium of claim 12 wherein the first graphical user interface controls provide a free-form drawing tool for receiving the indications of the one or more sensitive geographical areas.

14. The computer-readable storage medium of claim 12 wherein the first graphical user interface controls provide a plurality of pre-defined geographical area sizes for selection by the user to indicate the one or more sensitive geographical areas.

15. The computer-readable storage medium of claim 12 wherein the first graphical user interface controls provide:
a selectable random offset option to randomly offset a sensitive geographical area of the one or more sensitive geographical areas.

16. The computer-readable storage medium of claim 12 wherein the first graphical user interface controls are configured to, for a sensitive geographical area of the one or more sensitive geographical areas:
receive, from the user, a specific geographical location identifying a center of the sensitive geographical area;
receive, from the user, a radius from the center of the sensitive geographical area; and
receive, from the user, a selection of a random offset option to randomly offset the specific geographical location to a new location, wherein the new location and radius define the sensitive geographical area, and wherein the received specific geographical location is within the sensitive geographical area after the random offset option is applied.

17. The computer-readable storage medium of claim 12 wherein the second graphical user interface controls are further configured to:
provide a privacy option to remove geographical location from photos when shared for photos having geographical location within at least one of the one or more sensitive geographical areas; and
provide a privacy option to generalize geographical location from photos when shared for photos having geographical information within at least one of the one or more sensitive geographical areas.

18. The computer-readable storage medium of claim 12 wherein the second graphical user interface controls are further configured to:
provide a control for receiving, from the user, a selection of a generalized geographical location option to use when the privacy option to use a generalized geographical location applies.

19. The computer-readable storage medium of claim 12 wherein the second graphical user interface controls are further configured to:
provide a control for presenting, to the user, a plurality of generalized geographical location options; and
provide a control for receiving, from the user, a selection of a generalized geographical location option, from the plurality of generalized geographical location options;
wherein digital photos will use the selected generalized geographical location option when the privacy option to use a generalized geographical location is applied.

20. The computer-readable storage medium of claim 12 wherein the second graphical user interface controls are further configured to:
provide a control for applying selected privacy options to previously saved digital photos.
